(19) United States
(12) Patent Application Publication
(10) Pub. No.: US 2011/0272316 A1
(43) Pub. Date: Nov. 10, 2011

(54) LABELING DEVICE FOR CONTAINER, AND RELATED MANUFACTURING METHOD

(75) Inventors: Jacques Barange, Champillon (FR); Jerome Collard, Ay (FR); Christian Gonzalez, Hautvilliers (FR)

(73) Assignee: EOS, Dizy (FR)

(21) Appl. No.: 13/132,415

(22) PCT Filed: Nov. 24, 2009
(86) PCT No.: PCT/FR09/52281

§ 371 Date: Jun. 2, 2011

(30) Foreign Application Priority Data
Dec. 2, 2008 (FR) 0858199
Apr. 24, 2009 (FR) 0952710

(51) Int. Cl. B65D 85/00; B29C 45/14

(52) U.S. Cl. 206/459.5; 264/255

(57) ABSTRACT

A labeling device for a container, for example for a bottle containing a drinking liquid, includes at least one sleeve for covering at least one portion of the container. The sleeve is made of resilient synthetic material and is sized so as to resiliently enclose the portion of the container after mounting the device onto the container.

Labeling device for container, notably for a bottle containing a liquid to be drunk, and related manufacturing method.

The present invention relates to a labeling device for a container and a related manufacturing method.

A particularly valuable application of the invention relates to the labeling of a bottle containing a liquid to be drunk. The device may also be used for the labeling of containers or bottles designed to contain other types of liquids, for example perfumes.

Bottles containing a liquid usually comprise various items of essential sale-related information and elements of decoration or publicity information, for example trademarks, logos, etc.

In order to apply such information to containers, it is customary to provide metal covers, adhesive labels or else films made of heat-shrinkable and printable plastic material covering all or a portion of the container.

With such solutions, it is necessary to provide several operations in order to obtain the labeling of the container.

In order to place such information on a glass container, it is also possible to provide direct prints, for example by heat transfer, enameling, lacquering or screen-printing. This however substantially increases the cost price of the container.

The object of the present invention is to remedy these drawbacks.

More particularly, the object of the present invention is to provide a labeling device for a container, which device is particularly easy to manufacture and install and is economical.

A further object of the present invention is to provide a labeling device that does not require adhesive in order to keep it on the associated container.

According to a first aspect, the invention relates to a labeling device for a container, notably for a bottle containing a liquid to be drunk, comprising at least one sleeve designed to cover at least one portion of the container. The sleeve is made of an elastic synthetic material and sized so as to elastically grip said portion of the container after the device is installed on the container. The sleeve comprises on its outer surface means for providing information and/or means of decoration made in one piece with said sleeve. These means can be in relief and/or hollowed out on the outer surface of the sleeve. These means may form publicity information, decoration, trademarks or else information relating to the liquid contained.

The inner portion or portions of the sleeve match in shape the portion or portions of the container designed to be covered. In the free state of the sleeve, i.e. when it is not installed on the bottle, the portion or portions of the sleeve have, in cross section, an inner perimeter less than the outer perimeter of the corresponding portion or portions of the container. The device is held on the container by the elastic grip of the sleeve.

It becomes possible to install the device and label the bottle in a single operation without using additional means such as glues or adhesives.

Moreover, with such a device, it is possible to provide at less cost specific outer shapes that may be different from that of the associated bottle. It is possible to provide, for one and the same bottle type, a plurality of labeling devices having an outer appearance that is substantially different from that of the bottle and conferring on it the desired special shape, for example for promotional operations. It is therefore possible to obtain bottles labeled with devices of different shapes without it being necessary to change the bottling line to a new bottle format, the labeling of the bottles being carried out during a final operation.

Furthermore, when bottles fitted with these devices are stored inside a carton, it is not necessary to provide spacers between them in order to prevent them colliding during subsequent transport. Specifically, the sleeves partially or completely covering the bottles make it possible to absorb the impacts, which substantially reduces the risk of breakage of the bottles. It becomes possible to display the bottles on a shelf by directly using the carton that has been used for their transport.

Moreover, in the case of a bottle containing a liquid to be drunk, the sleeve makes it possible to delay the heating of the contained liquid when the bottle has been previously cooled. The sleeve thus forms a means of heat protection for the contained liquid.

Preferably, one or more portions of the sleeve capable of resiliently enclosing the portion or portions of the container each have, in the free state, in cross section, an inner perimeter that is 1 to 15% less than the outer perimeter of the corresponding portion or portions of the container, and preferably less than 7%.

Advantageously, the sleeve is made of a thermoplastic elastomer (TPE).

The sleeve may comprise, at a top end, a collar extending outward. Alternatively, or additionally, the sleeve may comprise, at a bottom end, a radial collar extending inward.

In one embodiment, the sleeve comprises, on its outer surface, at least one recess, hook or clip for the coupling of an element outside the device. The recess is advantageously designed not to be open-ended. It is also possible to provide, on the outer surface, a surface suitable for gluing.

According to a second aspect, the invention also relates to a bottle containing a liquid to be drunk, notably a fizzy liquid, furnished with a labeling device as defined above.

According to a third aspect, the invention also relates to a method for manufacturing a labeling device for a container, notably for a bottle containing a liquid to be drunk, wherein the elastic synthetic material(s) of a sleeve of the device designed to cover at least a portion of the container is(are) injected into a mold, the mold comprising a core adapted at least to the profile of the portion of the container to be covered, then one end of the molded sleeve is pulled so as to strip the device from the mold by reversing the sleeve. In one embodiment, the core comprises at least one engraving and/or one relief. Stripping from the mold can be carried out manually or in an automated manner.

With such a stripping from the mold by reversing the sleeve, after having installed the device on the container to be labeled, the traces of the mold parting line and any possible burrs of material that may be present on the sleeve are no longer visible from the outside by the consumer. Specifically, after the device is stripped from the mold, these molding traces are on the inner surface of the sleeve designed to come against the container to be labeled. After the device is stripped from the mold, the presence of molding marks on the outer surface of the sleeve that may cause a negative impression for the consumer is avoided.

Moreover, stripping the device from the mold by reversing the sleeve makes it possible to provide on the core of the mold etchings and/or reliefs making it possible to obtain on the sleeve the publicity information, the decoration, the trademarks, the information relating to the contained liquid, etc., that are intended to be seen by the consumer when the device is installed on the associated container. Placing the engravings and/or reliefs on the core makes it possible to substantially reduce the manufacturing cost of the manufacturing mold relative to placing these engravings and/or reliefs on one or both portions forming the mold.

Producing the device by molding plastic material also means that it is possible to easily change its color and vary its roughness by polishing, dulling, sanding etc. the core of the mold. It is also easy to obtain sleeves having very different visible appearances and feels. Moreover, it is possible to obtain, at less cost, devices of different and original shapes that are especially adapted to the containers on which they are intended to be installed.

The present invention will be better understood on studying embodiments taken as nonlimiting examples and illustrated by the appended drawings, in which:

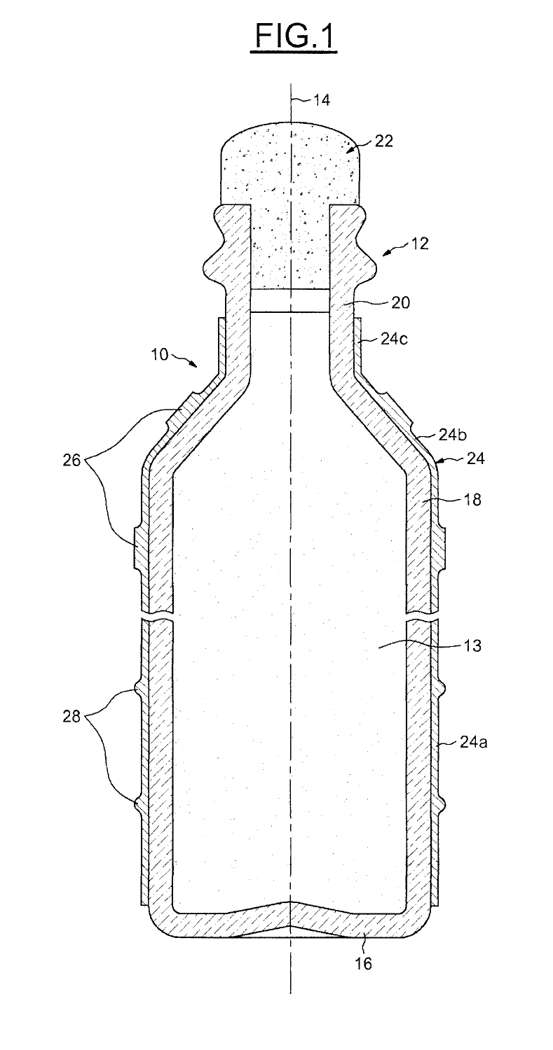

FIG. 1 is a view in section of a labeling device installed on a bottle according to a first embodiment of the invention,

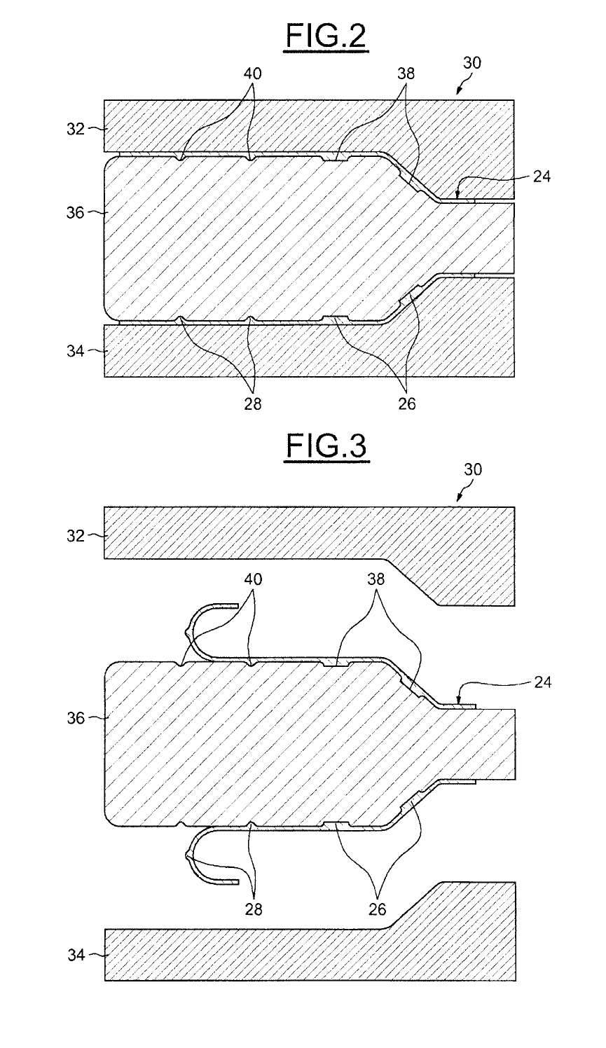

FIGS. 2 to 5 illustrate schematically the method for manufacturing the labeling device of FIG. 1, and

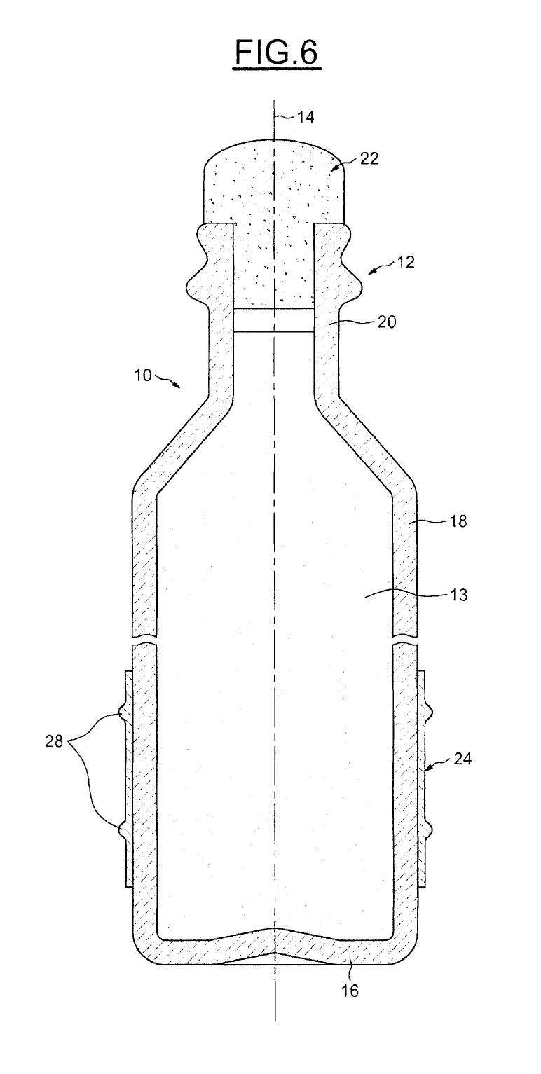

FIGS. 6 to 8 are respectively views in section of labeling devices installed on bottles according to second, third and fourth embodiments of the invention.

FIG. 1 shows a device 10 designed for the labeling of a bottle 12. In the figure, the device 10 and the bottle 12 are shown in an assumed vertical position.

The device 10 may be used for labeling a bottle containing a liquid 13 to be drunk, for example water, wine, fruit juice, an alcoholic drink, or else a fizzy drink such as soda or Champagne.

Naturally, the device 10 may also be used for labeling bottles or containers designed to contain other types of liquids, for example perfumes.

The bottle 12, with a vertical axis 14, is closed at its bottom end by a bottom 16 extended axially upward by a cylindrical side wall 18, itself extended by a frustoconical portion, then by a cylindrical neck 20 the top end of which is closed off by the stopper 22.

In a manner known per se, the stopper 22 in this instance comprises a stopping portion installed inside the neck 20 of the bottle extended by a head portion of generally spherical shape. A shoulder is formed between these portions and defines an annular bearing surface capable of coming into contact against the top end of the neck 20. Naturally, it is possible to use other stoppers of different shapes or else other means for closing off the bottle, for example a cap.

The device 10 comprises a sleeve 24 in the form of a tubular casing radially surrounding the majority of the bottle 12 and coming into contact against the latter. More precisely, the sleeve 24 presses against the side wall 18, the frustoconical portion and the neck 20 of the bottle.

As will be described in greater detail below, the sleeve 24 is obtained by molding a synthetic material so as to match the shape of the portions of the bottle 12 that are to be covered. The material of the sleeve 24 is an elastic flexible synthetic material. It may for example be made of a thermoplastic elastomer (TPE). As an indication, it is possible to use the thermoplastic elastomer sold under the trademark Onflex® from the company Polyone or else that sold under the trademark Teflaboc® from the company CTS. Alternatively, it is also possible to make the sleeve with an elastomer, for example of rubber, silicone, natural latex or else recycled elastomers.

The sleeve 24 has a cylindrical portion 24a of large diameter surrounding the side wall 18 of the bottle which is extended by a frustoconical portion 24b tapering inward and coming to press against the frustoconical portion of the bottle, itself extended by a cylindrical portion 24c of small diameter partially covering the neck 20. The whole of the sleeve 24 presses against the bottle 12. The cylindrical portion 24a of large diameter, respectively of small diameter 24c, has, in the free state, an inner diameter less than the outer diameter of the side wall 18, respectively of the neck 20, of the bottle 12. The frustoconical portion 24b of the sleeve 24 has a variable inner diameter. In cross section, the inner diameter of this frustoconical portion 24b is less than the outer diameter of the frustoconical portion of the bottle 12. More precisely, in cross section, the sleeve 24 has, over the whole of its length, an inner diameter that is 1 to 15% less than the outer diameter of the corresponding covered portion of the bottle 12, and preferably less than 7%.

When the device 10 is fitted over the bottle 12, the device is deformed elastically which makes it possible subsequently to hold it axially on the bottle by elastic gripping of the sleeve 24. In this way, the sleeve 24 is held in position on the bottle 12 without the provision of additional means such as adhesives or glue.

In the illustrated embodiment, the bottle 12 is circular in cross section. Naturally, it is possible to provide bottles having a different cross section, for example elliptical or polygonal such as triangular, rectangular, square, hexagonal, octagonal, etc. In this case, in cross section, the inner perimeter of the associated sleeve is less than the outer perimeter of the bottle, and advantageously 1 to 15% less than this outer perimeter, and preferably less than 7%.

The sleeve 24 comprises, on its outer surface, protrusions or protuberances 26, 28 which in this instance in a nonlimiting manner have a generally annular shape. The protuberances 26, 28 are made in one piece with the sleeve 24. Specifically, they are obtained when the sleeve 24 is molded. Advantageously, these protuberances 26, 28 may be used to form on the sleeve 24 publicity information, decoration, trademarks, making it possible to identify the product, or else information relating to the contained liquid. Since the sleeve 24 is obtained by molding, it is understandable that it is possible to easily provide information, decoration, trademarks, etc., of complex shapes and specific to the associated bottle 12. As an alternative or as an addition to the protuberances 26 and 28 forming reliefs, it is of course possible to provide on the outer surface of the sleeve 24 detents or recesses which may or may not pass through the thickness of the sleeve so as to partly or wholly form these items of information, decoration, trademarks, etc., or in order to allow the coupling of a part or element external to the sleeve 24, for example a publicity medium. As an indication, the thickness of the sleeve may be between 0.8 and 3 mm. Naturally, it is possible to provide a greater thickness.

As illustrated in FIGS. 2 to 5, in order to manufacture the device 10, a mold 30 is used comprising portions 32, 34 that can be moved relative to one another and a central core 36 provided between these portions so as to delimit a cavity of the sleeve 24 that is to be installed on the bottle 12 (FIG. 1). The core 36 is conformed to the desired profile and dimensions of the sleeve 24 so that it matches the bottle. The core 36 comprises, on its surface, recessed portions or engravings 38, 40 making it possible to obtain the formation of the protuberances 26, 28 when the sleeve 24 is molded.

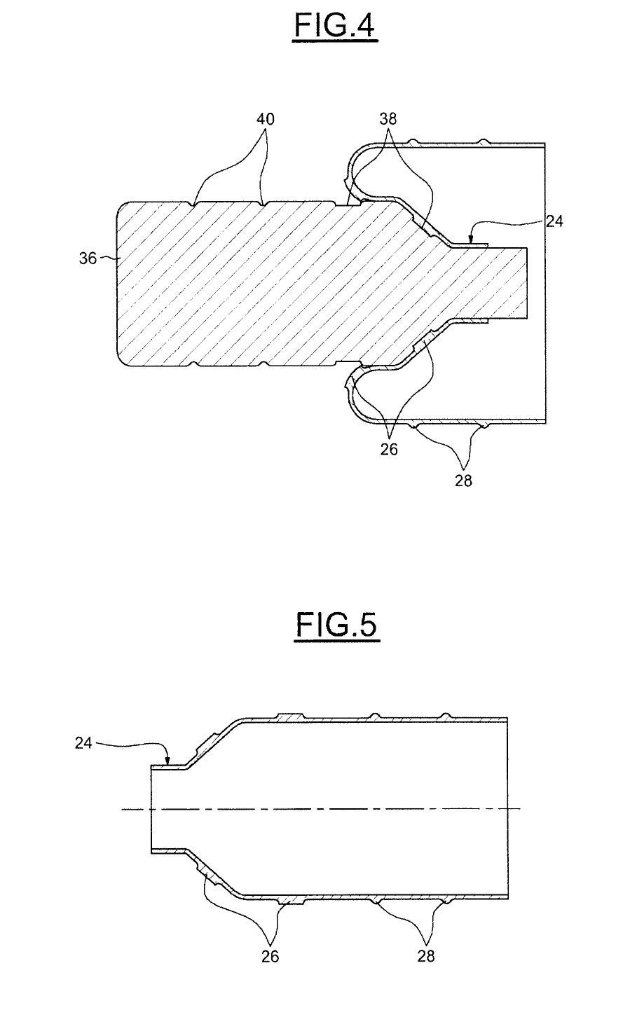

When the mold 30 is closed around the punch 36, the plastic material is injected in order to obtain the sleeve 24 of the device 10. After the portions 32, 34 of the mold (FIG. 3) are opened, the sleeve 24 placed on the core 36 is stripped from the mold. With respect to this, the large-diameter end of the sleeve 24 is pulled so as to withdraw it from the core 36 by rolling it up in the direction of the opposite end of small diameter of the sleeve 24 (FIG. 4). The sleeve 24 is pulled until it is fully withdrawn from the core 36.

The device 10 is stripped from the mold by reversing the sleeve 24 so that the surface comprising the protuberances 26, 28 which, after molding, is in contact with the core 36 forms, after being stripped from the mold, the outer surface of the sleeve 24 (FIG. 5). The surface of the sleeve 24 initially in contact with the portions 32, 34 of the mold forms, after being stripped from the mold, the inner surface of the sleeve 24 intended to press against the bottle. Therefore, the traces of the mold parting line 30 and any possible burrs of material on this parting line are not visible on the sleeve 24 for the consumer when the device 10 is installed on the bottle 12. Conversely, the protuberances 26, 28 that are present on the outer surface of the sleeve 24 and may form publicity information, decoration or trademarks making it possible to identify the product, or else information relating to the contained liquid can be seen by the consumer. After the sleeve 24 has been stripped from the mold, the device 10 can be force-fitted onto the bottle 12. To make it easier to install the sleeve 24 on the bottle 12, it is possible to use lubricants such as silicone, water, soap, etc.

In this embodiment, the sleeve 24 and the protuberances 26, 28 are obtained by molding of a single plastic material. It is however possible to provide an overmolding of the protuberances 26, 28 onto the sleeve 24 with a second plastic material having for example a different color or hardness. After overmolding, the protuberances 26, 28 are in one piece with the sleeve 24.

In the embodiment described, the sleeve 24 covers the majority of the outer surface of the bottle 12. Naturally, the axial dimension or height of the sleeve can be modified and for example have a height substantially equal to that of the labels conventionally stuck to the bottles containing a liquid to be drunk, as is shown in the embodiment of FIG. 6 in which the identical elements bear the same reference numbers.

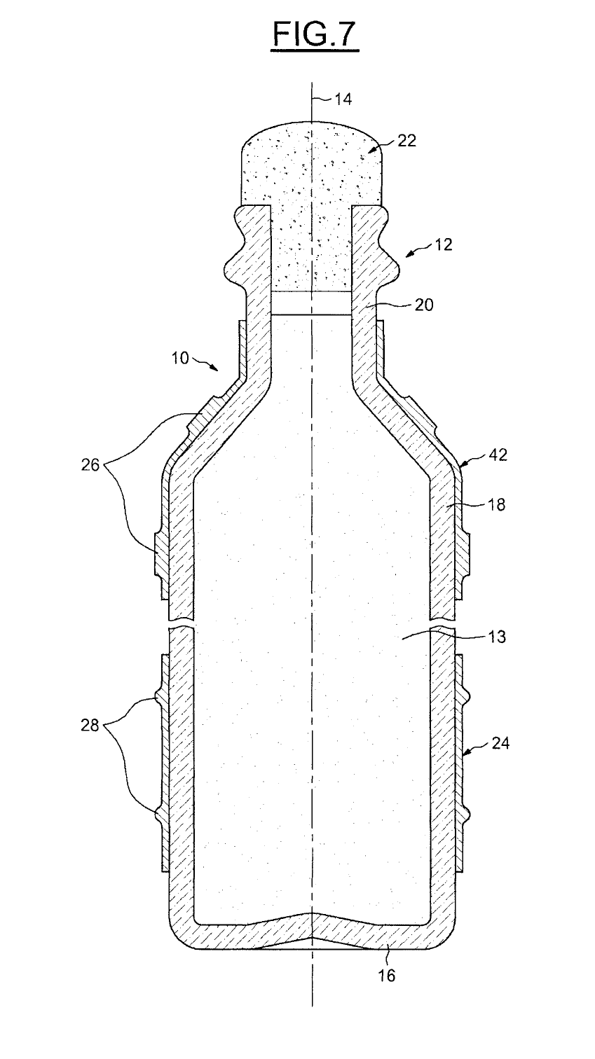

The variant embodiment of FIG. 7 differs from the embodiment of FIG. 6 only in that the device 10 comprises a second sleeve 42 gripping another portion of the bottle and being offset axially relative to the first sleeve 24. The sleeve 42 comprises protuberances 26. Naturally, it is possible to provide a greater number of sleeves.

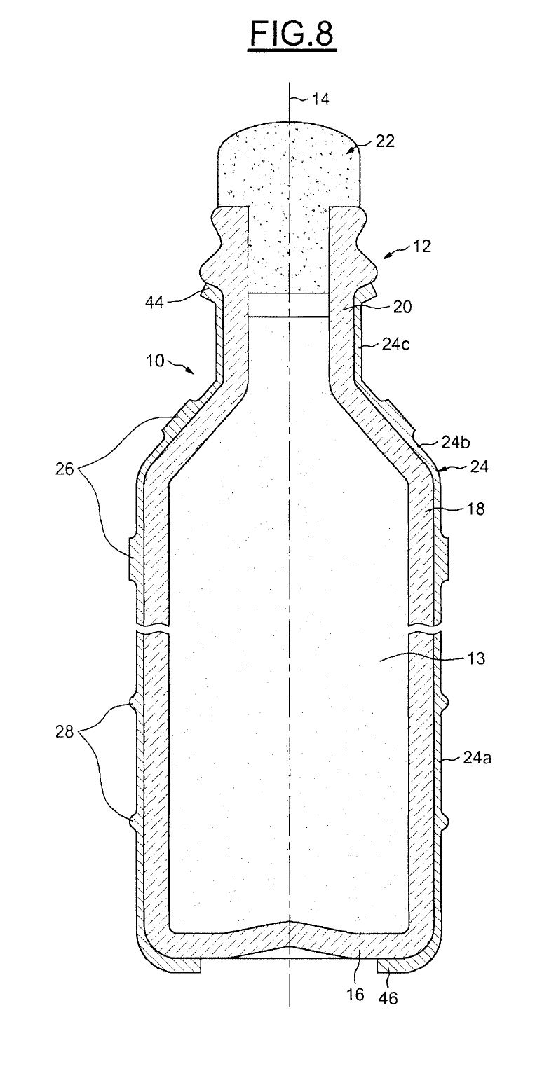

The embodiment illustrated in FIG. 8, in which the identical elements bear the same reference numbers, differs from the first embodiment in that the sleeve 24 comprises, at its top end, a collar 44 that is thicker than the sleeve. The collar 44 extends radially outward and presses against the bead of the neck 20 of the bottle. This collar 44 makes it possible to locally increase the stretch-resistance of the sleeve 24 so as to prevent a possible deformation of its top end when the device 10 is fitted onto the bottle 12, and more precisely when the top end of the sleeve 24 travels to the bead of the bottle 12 which has a larger diameter than that of the portion of the neck 20 intended to be covered by this end.

The sleeve 24 also comprises, at its bottom end, a collar 46 that is thicker than the sleeve. The collar extends radially inward and is designed to press against the bottom 16 of the bottle so as to prevent a possible upward axial movement of the sleeve 24. The collar 46 forms a means for holding the sleeve 24 in position on the bottle 12. The collars 44, 46 may have without distinction a profile which in cross section is rectangular, square, triangular, round, etc.

By virtue of the invention, the user has a device comprising a low-cost molded sleeve making it easy to label a container and able to have on its outer surface publicity information, decoration, trademarks or else information relating to the contained liquid. Obtaining the sleeve by molding makes it possible to easily modify the feel, the appearance and the colors of the device. Moreover, the device makes it possible to obtain, at less cost, a labeling of the bottle for example with a special shape that is distinct from the profile of the bottle.

1-9. (canceled)

10. A labeling device for a container, or for a bottle containing a liquid to be drunk, comprising:
at least one sleeve configured to cover at least one portion of the container, the sleeve being made of an elastic synthetic material and sized so as to elastically grip the at least one portion of the container after the device is installed on the container,
wherein the sleeve comprises on its outer surface means for providing information and/or means for decoration made in one piece with the sleeve.

11. The device as claimed in claim 10, wherein one or more portions of the sleeve capable of elastically gripping the at least one portion of the container have, in a free state, in cross section, an inner perimeter that is 1 to 15% less, or less than 7%, than a corresponding outer perimeter of the at least one portion of the container.

12. The device as claimed in claim 10, wherein the sleeve is made of a thermoplastic elastomer.

13. The device as claimed in claim 10, wherein the sleeve comprises, at a top end, a collar extending outward.

14. The device as claimed in claim 10, wherein the sleeve comprises, at a bottom end, a radial collar extending inward.

15. The device as claimed in claim 10, wherein the sleeve comprises, on its outer surface, at least one recess or hook for the coupling of an element outside the device.

16. A bottle containing a liquid or a fizzy liquid to be drunk, comprising a labeling device as claimed in claim 10.

17. A method for manufacturing a labeling device for a container, or for a bottle containing a liquid to be drunk, comprising:
injecting an elastic synthetic material of a sleeve of a device configured to cover at least a portion of the container into a mold, the mold comprising a core adapted at least to a profile of the at least one portion of the container to be covered;
then pulling one end of the molded sleeve so as to strip the device from the mold by reversing the sleeve.

18. The method as claimed in claim 17, wherein the core comprises at least one engraving and/or one relief.
